(19) United States
(12) Patent Application Publication
(10) Pub. No.: US 2019/0009581 A1
(43) Pub. Date: Jan. 10, 2019

(54) PRINTER

(71) Applicant: Hewlett-Packard Development Company, L.P, Houston, TX (US)

(72) Inventors: Wesley R Schalk, Camas, WA (US); Kevin Lo, Vancouver, WA (US); Steve O Rasmusse, Vancouver, WA (US); Peter J Boucher, Vancouver, WA (US); Richard Lee Brinkly, Camas, WA (US); Alexander M Nameroff, Portland, OR (US)

(21) Appl. No.: 16/067,288

(22) PCT Filed: Apr. 29, 2016
(86) PCT No.: PCT/US2016/063018

§ 371 Date: Jun. 29, 2018

(51) Int. Cl. B41J 11/50; B41J 2/175; B41J 13/10; B41J 11/00

(52) U.S. Cl. CPC B41J 11/50; B41J 2/175; B65H 2801/06; B41J 11/006; B41J 13/10

(57) ABSTRACT

A printer includes a print engine to print on print media within a print zone, a print media path including a print path portion to direct the print media through the print zone in a first direction, a duplex media path including a duplexing path portion to redirect the print media to the print media path in a second direction opposite the first direction, and a first tandem media tray to hold a first quantity of the print media and a second tandem media tray positioned laterally of the first tandem media tray to hold a second quantity of the print media, wherein the duplexing path portion extends a combined width of the first tandem media tray and the second tandem media tray.

### BACKGROUND

A printer may include a print media path to move and/or route print media through the printer, a print engine to print on the print media, and a duplexer to facilitate printing on both sides of the print media. For use in an office environment, printer features such as printed media being output face-down in an output bin (for example, for security, confidential, and/or privacy concerns), minimal occupied footprint, and/or convenient use height, may be considered.

### BRIEF DESCRIPTION OF THE DRAWINGS

FIG. 1 is a schematic illustration of one example of a layout of a portion of a printer.

FIG. 2 is a block diagram illustrating one example of an inkjet printing system.

FIG. 3 is a schematic illustration of one example of a printhead assembly of an inkjet printing system.

FIG. 4 is a schematic illustration of one example of a layout of a portion of a printer.

FIG. 5 is a schematic illustration of one example of a media handling layout of the printer of FIG. 4.

FIG. 6 is a schematic illustration of one example of a layout of a portion of a printer.

FIG. 7 is a schematic illustration of one example of a media handling layout of the printer of FIG. 6.

FIG. 8 is a schematic illustration of one example of an internal access configuration of the printer of FIG. 6.

FIG. 9 is a flow diagram illustrating one example of a method of operating a printer.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

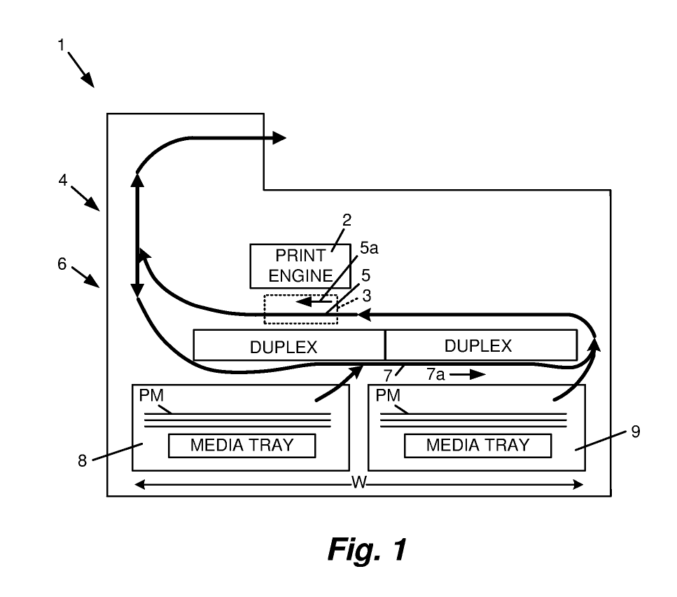

In one implementation, as illustrated in the example of FIG. 1, the present disclosure provides a printer 1 including a print engine 2 to print on print media (PM) within a print zone 3, a print media path 4 including a print path portion 5 to direct the print media through the print zone in a first direction 5a, a duplex media path 6 including a duplexing path portion 7 to redirect the print media to the print media path in a second direction 7a opposite the first direction, and a first tandem media tray 8 to hold a first quantity of the print media and a second tandem media tray 9 positioned laterally of the first tandem media tray to hold a second quantity of the print media, wherein the duplexing path portion extends a combined width (W) of the first tandem media tray and the second tandem media tray.

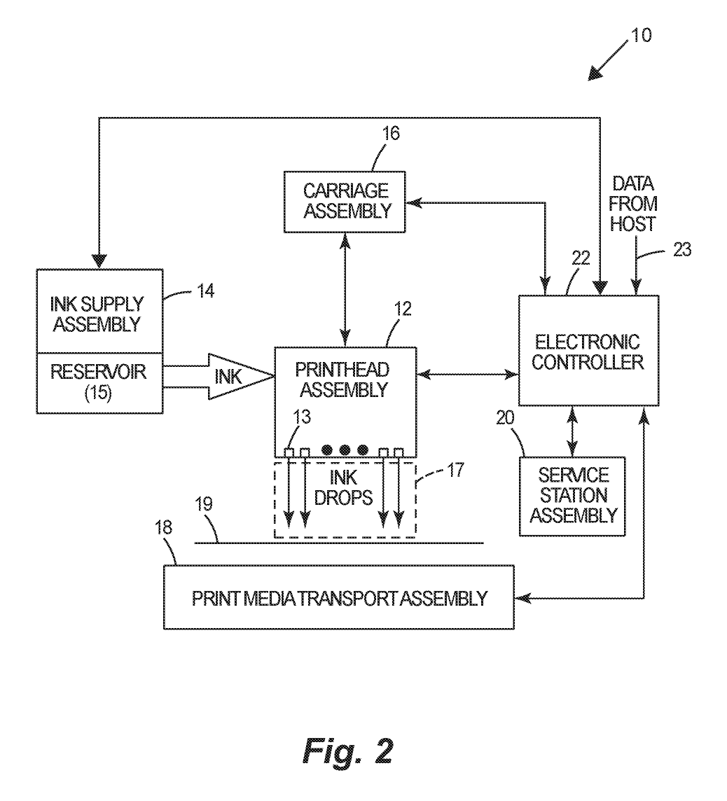

FIG. 2 illustrates one example of an inkjet printing system 10, as an example of printer 1. Inkjet printing system 10 includes a fluid ejection assembly, such as printhead assembly 12, and a fluid supply assembly, such as ink supply assembly 14. In the illustrated example, inkjet printing system 10 also includes a carriage assembly 16, a print media transport assembly 18, a service station assembly 20, and an electronic controller 22.

Printhead assembly 12 includes one or more printheads or fluid ejection devices which eject drops of ink or fluid through a plurality of orifices or nozzles 13. In one example, the drops are directed toward a medium, such as print media 19, so as to print onto print media 19. Print media 19 includes any type of suitable sheet material, such as paper, card stock, transparencies, Mylar, fabric, and the like. Typically, nozzles 13 are arranged in one or more columns or arrays such that properly sequenced ejection of ink from nozzles 13 causes characters, symbols, and/or other graphics or images to be printed upon print media 19 as printhead assembly 12 and print media 19 are moved relative to each other.

Ink supply assembly 14 supplies ink to printhead assembly 12 and includes a reservoir 15 for storing ink. As such, in one example, ink flows from reservoir 15 to printhead assembly 12. In one example, printhead assembly 12 and ink supply assembly 14 are housed together in an inkjet or fluid-jet print cartridge or pen. In another example, ink supply assembly 14 is separate from printhead assembly 12 and supplies ink to printhead assembly 12 through an interface connection, such as a supply tube.

Carriage assembly 16 positions printhead assembly 12 relative to print media transport assembly 18 and print media transport assembly 18 positions print media 19 relative to printhead assembly 12. Thus, a print zone 17 is defined adjacent to nozzles 13 in an area between printhead assembly 12 and print media 19. In one example, printhead assembly 12 is a scanning type printhead assembly such that carriage assembly 16 moves printhead assembly 12 relative to print media transport assembly 18. In another example, printhead assembly 12 is a non-scanning type printhead assembly such that carriage assembly 16 fixes printhead assembly 12 at a prescribed position relative to print media transport assembly 18.

Service station assembly 20 provides for spitting, wiping, capping, and/or priming of printhead assembly 12 in order to maintain a functionality of printhead assembly 12 and, more specifically, nozzles 13. For example, service station assembly 20 may include a rubber blade or wiper which is periodically passed over printhead assembly 12 to wipe and clean nozzles 13 of excess ink. In addition, service station assembly 20 may include a cap which covers printhead assembly 12 to protect nozzles 13 from drying out during periods of non-use. In addition, service station assembly 20 may include a spittoon into which printhead assembly 12 ejects ink to insure that reservoir 15 maintains an appropriate level of pressure and fluidity, and insure that nozzles 13 do not clog or weep. Functions of service station assembly 20 may include relative motion between service station assembly 20 and printhead assembly 12.

Electronic controller 22 communicates with printhead assembly 12, carriage assembly 16, print media transport assembly 18, and service station assembly 20. Thus, in one example, when printhead assembly 12 is mounted in carriage assembly 16, electronic controller 22 and printhead assembly 12 communicate via carriage assembly 16. Electronic controller 22 also communicates with ink supply assembly 14 such that, in one implementation, a new (or used) ink supply may be detected, and a level of ink in the ink supply may be detected.

Electronic controller 22 receives data 23 from a host system, such as a computer, and may include memory for temporarily storing data 23. Data 23 may be sent to inkjet printing system 10 along an electronic, infrared, optical or other information transfer path. Data 23 represents, for example, a document and/or file to be printed. As such, data 23 forms a print job for inkjet printing system 10 and includes one or more print job commands and/or command parameters.

In one example, electronic controller 22 provides control of printhead assembly 12 including timing control for ejection of ink drops from nozzles 13. As such, electronic controller 22 defines a pattern of ejected ink drops which form characters, symbols, and/or other graphics or images on print media 19. Timing control and, therefore, the pattern of ejected ink drops, is determined by the print job commands and/or command parameters. In one example, logic and drive circuitry forming a portion of electronic controller 22 is located on printhead assembly 12. In another example, logic and drive circuitry forming a portion of electronic controller 22 is located off printhead assembly 12.

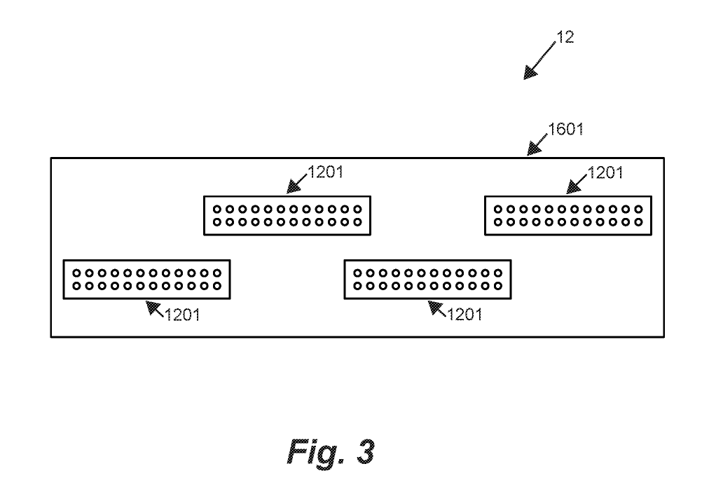

In one example, as illustrated in FIG. 3, printhead assembly 12 is a wide-array or multi-head printhead assembly and includes a carrier 1601, as an example of carriage assembly 16, and a plurality of printhead dies 1201 mounted on carrier 1601. In one implementation, printhead dies 1201 are arranged and aligned in one or more overlapping rows (as oriented in FIG. 3) such that printhead dies 1201 in one row overlap at least one printhead die 1201 in another row. As such, printhead assembly 12 may span a nominal page width or a width shorter or longer than a nominal page width. For example, printhead assembly 12 may span 8.5 inches of a Letter size print medium or a distance greater than or less than 8.5 inches of the Letter size print medium. While four printhead dies 1201 are illustrated as being mounted on carrier 1601, the number of printhead dies 1201 mounted on carrier 1601 may vary.

In one implementation, printhead assembly 12, as a wide-array or multi-head printhead assembly including printhead dies 1201, is a non-scanning type printhead assembly such that carrier 1601 fixes printhead assembly 12 at a prescribed position relative to print media transport assembly 18 (FIG. 2). With a position of printhead assembly 12 fixed, print media 19 (FIG. 2) is moved or advanced relative to printhead assembly 12 during printing.

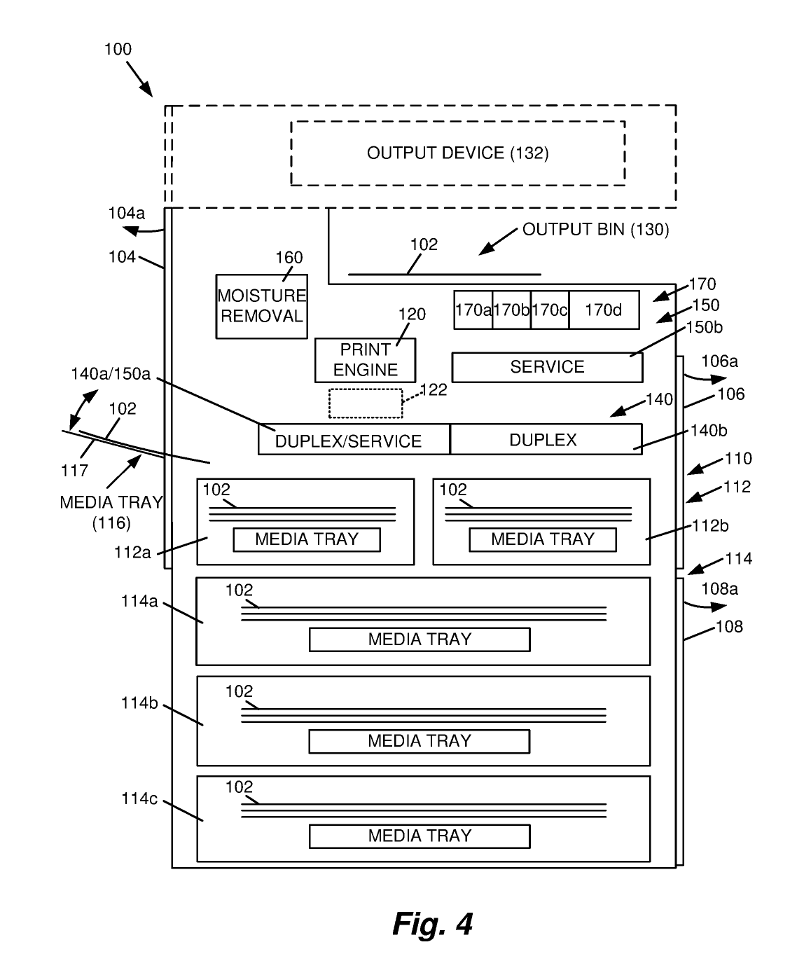

FIG. 4 is a schematic illustration of one example of a layout of a portion of a printer 100. In one implementation, printer 100 includes an input tray or trays 110 to supply print media 102, as an example of print media 19, a print engine 120 to print on print media 102, an output tray or bin 130 to receive printed print media 102, a duplex module 140 to facilitate two-sided printing on print media 102, and a service module or modules 150 to service print engine 120. In one implementation, printer 100 also includes a moisture removal unit 160 to facilitate removal of moisture from printed print media 102.

In one implementation, printer 100 includes an additional output device 132, such as a finisher or second output tray or bin to receive printed print media 102. In one example, output device 132 is a modular component and may be added (or removed) to vary a configuration (i.e., media output handling) of printer 100. In addition, in one implementation, a scanner and/or automatic document feeder may be positioned above output bin 130 or output device 132.

Input trays 110, as described below, supply a bulk quantity of print media 102 or supply a single quantity of print media 102 to print engine 120 for printing on print media 102 by print engine 120. In one implementation, input trays 110 include a tandem media tray set 112, at least one media tray 114, and a manual or bypass media tray 116 (also known as a multi-purpose tray).

In one implementation, tandem media tray set 112 includes a tandem media tray 112a and a tandem media tray 112b. Tandem media tray 112a and tandem media tray 112b are positioned side-by-side or laterally of each other, and each hold a separate quantity of print media. In one example, tandem media tray 112a and tandem media tray 112b each have the same capacity, for example, a 500 sheet capacity (i.e., one ream) or more.

In one implementation, media tray 114 includes multiple media trays 114a, 114b, and 114c which are positioned vertically of each other, and each hold a separate quantity of print media. In one example, media trays 114a, 114b, and 114c each have a 500 sheet capacity (i.e., one ream) or more. In one example, media trays 114a, 114b, and 114c are accessory or auxiliary media trays, and may be added (or removed) to vary a configuration (i.e., media handling and/or capacity) of printer 100. While three media trays 114a, 114b, and 114c are illustrated and described, the number of media trays 114 may vary, including no media tray 114 such that the number of media trays 114 may be zero through N.

In one implementation, bypass media tray 116 includes a door 117 which is selectively opened (and closed) (as indicated by the double arrow) to facilitate manual input of print media 102 to printer 100. More specifically, bypass media tray 116 receives manual input of print media 102 from externally of printer 100 such that print media 102 is directed to print engine 120 for printing, as described below. Print media manually input to printer 100 may include, for example, envelopes, letterhead, checks, or other print media suited for single or manual input. Bypass media tray 116 may also support quantities of print media such as multi-sheet stacks of print media for input to printer 100.

Print engine 120 can be a laser print engine, an inkjet print engine, or any other type of print engine. In one implementation, a print area or print zone 122 is defined in which printing on print media 102 by print engine 120 occurs. In one example, printer 100 is implemented as an inkjet printing system, such as inkjet printing system 10, and print engine 120 includes, for example, printhead assembly 12. When print engine 120 is implemented as an example of printhead assembly 12, print zone 122 includes print zone 17 as defined between printhead assembly 12 and print media 19 (FIG. 2).

Output bin 130 is provided at an end of a print media path through printer 100, as described below. In one implementation, output bin 130 holds printed output in a face-down orientation (i.e., the side of the print media just printed by the print engine faces the output bin when the printed print media is output). By providing face-down output in output bin 130, security, confidential, and/or privacy concerns are addressed since a front of the printed print media 102 is not visible. In addition, with face-down output in output bin 130, a correct print order of a multi-page print job may be achieved in that a first page of the multi-page print job may be printed first and output first (FIFO). As such, processing time of a multi-page print job may be minimized since each page of the multi-page print job may be processed in-order (i.e., first to last) as compared to reverse processing of a multi-page print (i.e., last page first) and outputting of the multi-page print job in a face-up orientation. In one example, output bin 130 has a 500 sheet capacity (i.e., one ream). In one example, output bin 130 is excluded such that a media transport path to a separate output device is provided.

In one implementation, duplex module 140 includes duplex sub-modules 140a and 140b which can be operated to facilitate printing on both sides of print media 102, as described below. In addition, service module 150 includes service modules 150a and/or 150b which provide for servicing of print engine 120, and which may be implemented as examples of service station assembly 20 to provide for spitting, wiping, capping and/or priming of printhead assembly 12, as described above, when print engine 120 is implemented as an example of printhead assembly 12. Furthermore, moisture removal unit 160 facilitates removal or reduction of moisture from printed print media. In one example, moisture removal unit 160 includes a drying unit which applies heat in a form of heated air to liquid ink, such as water-based ink disposed on print media, to remove water from the liquid ink.

In one implementation, printer 100 includes a printing fluid supply 170, as an example of ink supply assembly 14, to supply printing fluid to print engine 120. In one example, printing fluid supply 170 includes quantities of different colored liquid inks such as yellow 170a, cyan 170b, magenta 170c, and black 170d.

In one example, an access door 104 (openable in the direction indicated by arrow 104a) is provided at a side of printer 100 adjacent duplex sub-module 140a, moisture removal unit 160, and an output portion of the print media path provided through printer 100. In addition, access doors 106 and 108 (openable in the direction indicated by arrows 106a and 108a) are provided at a side of printer 100 adjacent printing fluid supply 170, service module 150b, duplex sub-module 140b, and an input portion of the print media path provided through printer 100. As such, access doors 104, 106, and/or 108 provide access to internal of printer 100, for example, for the clearance of print media jams and/or other service. In one example, with printer 100 including output device 132, access door 104 is extended to provide access to output device 132.

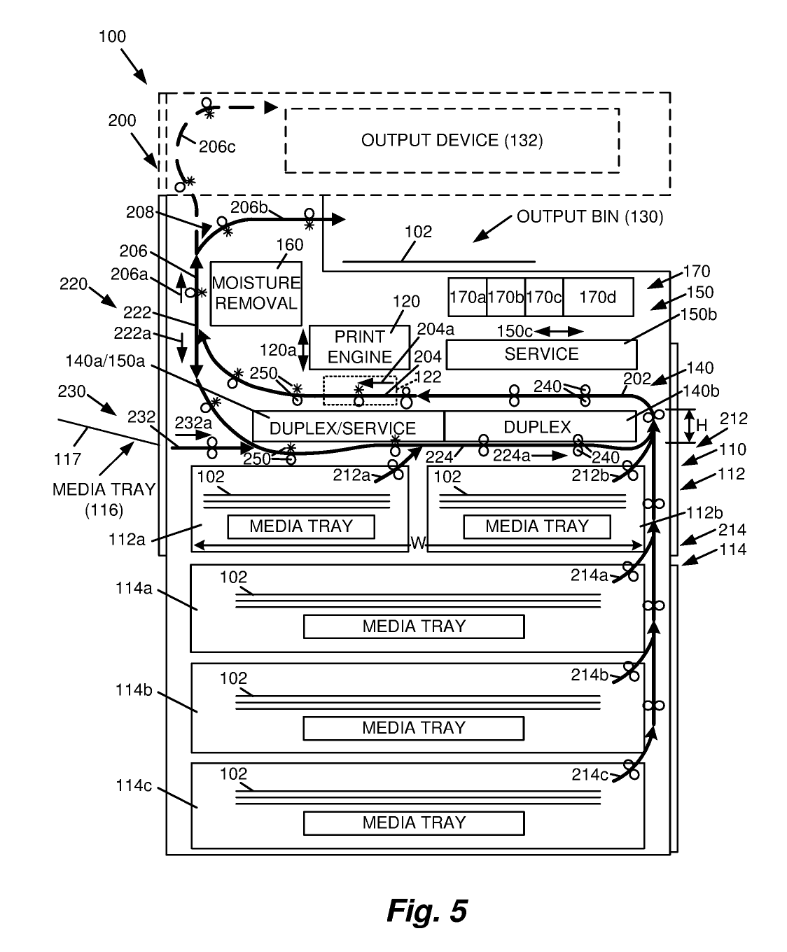

FIG. 5 is a schematic illustration of one example of a media handling layout of printer 100. The media handling layout of printer 100 may include a variety of guides, rollers, wheels, etc. to achieve the handling and routing of print media described below. As illustrated in the example of FIG. 5, and with reference to FIG. 4, printer 100 includes a print media path 200 which routes print media 102 through printer 100 for printing on print media 102 by print engine 120. More specifically, print media path 200 routes print media 102 from one or more of input trays 110, to and through print zone 122 of print engine 120, and to output bin 130 (or output device 132).

In one implementation, print media path 200 includes an input path portion 202, a print path portion 204, and an output path portion 206. Input path portion 202 communicates with and receives input of print media 102 from a tandem tray media path 212 communicated with tandem media tray set 112, including tandem media tray 112a and/or tandem media tray 112b, from an auxiliary media path 214 communicated with media tray (or trays) 114, including media tray 114a, media tray 114b, and/or media tray 114c, and/or from a bypass media path communicated with bypass media tray 116. As such, in one implementation, input path portion 202 provides a common input path for tandem media tray set 112, media tray (or trays) 114, and bypass media tray 116.

Print path portion 204 communicates with and receives print media 102 from input path portion 202, and directs print media 102 through print zone 122 for printing on print media 102 by print engine 120. Output path portion 206 communicates with and receives print media 102 from print path portion 204, and directs printed print media 102 for output at output bin 130 (or output device 132).

In one implementation, print path portion 204 of print media path 200 includes a portion which directs print media 102 through print zone 122 in a direction indicated by arrow 204a, and output path portion 206 of print media path 200 includes a portion which directs print media 102 toward output bin 130 (or output device 132) in a direction indicated by arrow 206a. In one example, the direction indicated by arrow 204a is substantially horizontal, and the direction indicated by arrow 206a is substantially vertical such that the direction indicated by arrow 206a is substantially perpendicular to the direction indicated by arrow 204a.

In one implementation, output path portion 206 includes an output path portion 206b to output bin 130 and an output path portion 206c to output device 132. As such, in one example, print media path 200 includes an output diverter (i.e., diverging path mechanism) 208 to selectively divert print media 102 to output bin 130 or output device 132 (if present). In one example, output path portion 206c includes an S-shaped path portion with sweeping bend radii that reduce possible print media jams and accommodate routing of various size print media to output device 132 without increasing the footprint of printer 100.

As illustrated in the example of FIG. 5, printer 100 includes a duplex media path 220 which receives print media 102 and redirects print media 102 to print media path 200, including, for example, to input path portion 202, for routing to print path portion 204 to facilitate printing on a second side of print media 102. More specifically, after print media 102 is printed on a first side, duplex media path 220 reverses an orientation of print media 102 (i.e., “flips” print media 102) such that print media 102 is oriented for printing on a second side. After print media 102 is printed on the second side, print media 102 is routed by print media path 200, including, for example, by output path portion 206, to output bin 130 (or output device 132), as described above.

In one implementation, duplex media path 220 includes a reversing path portion 222 and a duplexing path portion 224. In one example, reversing path portion 222 is provided by a portion of output path portion 206 such that reversing path portion 222 coincides with output path portion 206. As such, reversing path portion 222 receives print media 102 from print path portion 204 and reverses a direction of print media 102, as indicated by arrow 222a, thereby reversing an orientation of print media 102 for duplex printing.

In one example, output path portion 206 is of sufficient length such that print media 102 in reversing path portion 222 remains concealed within printer 100 while a direction of print media 102 is reversed. As such, print media 102 is not exposed externally of printer 100 during a duplex operation. Thus, a user is prevented from touching or pulling print media 102 during a duplex operation.

Duplexing path portion 224 receives print media 102 from reversing path portion 222 and redirects print media 102 to input path portion 202 of print media path 200 (for routing to print path portion 204). In one implementation, during redirection of print media 102 to input path portion 202, duplexing path portion 224 includes a portion which directs print media 102 in a direction indicated by arrow 224a. In one example, the direction indicated by arrow 224a is opposite the direction indicated by arrow 204a such that the direction that duplexing path portion 224 directs print media 102 to input path portion 202 is opposite the direction that print path portion 204 directs print media 102 through print zone 122. As such, a compact arrangement of print media path 200 and duplex media path 220 is obtained.

In one example, one sheet of print media 102 may be routed through duplex media path 220 while another sheet of print media 102 is being routed through print media path 200 including, more specifically, while another sheet of print media 102 is being routed through print path portion 204 and print zone 122. Thus, increased throughput may be achieved since duplexing of one sheet (i.e., flipping) and printing of another sheet may be performed in parallel or contemporaneously.

As illustrated in the example of FIG. 5, printer 100 includes a bypass media path 230 which communicates with and extends between bypass media tray 116 and print media path 200. As such, bypass media path 230 communicates to an exterior of printer 100 to receive print media 102 from externally of printer 100 and direct print media 102 to print media path 200.

In one implementation, bypass media path 230 includes a bypass path portion 232 which directs print media 102 to input path portion 202 of print media path 200 in a direction indicated by arrow 232a. In one example, the direction indicated by arrow 232a is in a direction opposite the direction indicated by arrow 204a such that the direction that bypass path portion 232 directs print media 102 to print media path 200 (i.e., input path portion 202) is opposite the direction that print path portion 204 directs print media 102 through print zone 122. In one example, bypass media path 230 includes a portion of duplex media path 220 such that a portion of bypass media path 230 coincides with a portion of duplex media path 220. More specifically, bypass path portion 232 communicates with duplexing path portion 224 such that duplexing path portion 224 directs print media from bypass media tray 116 to input path portion 202. As such, a compact arrangement of bypass media path 230 and duplex media path 220 is obtained.

In one implementation, tandem tray media path 212 includes a tandem media tray path portion 212a which communicates with and extends between tandem media tray 112a and input path portion 202, and a tandem media tray path portion 212b which communicates with and extends between tandem media tray 112b and input path portion 202. In one example, tandem media tray path portion 212a includes a portion of duplex media path 220 such that a portion of tandem media tray path portion 212a coincides with a portion of duplex media path 220. More specifically, tandem media tray path portion 212a communicates with duplexing path portion 224 such that duplexing path portion 224 directs print media from tandem media tray 112a to input path portion 202. In one example, tandem media tray path portion 212a communicates with an intermediate portion (segment or length) of duplexing path portion 224. As such, a compact arrangement of tandem media tray path portion 212a and duplex media path 220 is obtained.

In one implementation, auxiliary media path 214 includes auxiliary media path portions 214a, 214b, and 214c which communicate with and extend between respective media trays 114a, 114b, and 114c and input path portion 202. In one example, auxiliary media path portions 214a, 214b, and 214c include a common or shared media path portion as communicated with input path portion 202. As such, a compact arrangement of auxiliary media path portions 214a, 214b, and 214c and input path portion 202 is obtained.

In one implementation, as outlined above, tandem media tray path portions 212a and 212b, auxiliary media path portions 214a, 214b, and 214c, bypass path portion 232, and duplexing path portion 224 communicate with and extend to input path portion 202 such that input path portion 202 provides a converging path portion of print media path 200. As such, a compact arrangement of print media path 200, duplex media path 220, and bypass media path 230 is obtained.

To achieve the handling and routing of print media described above, printer 100 may include a variety of guides, rollers, wheels, etc. In one implementation, print media path 200 and duplex media path 220 include a series of opposing rollers and/or wheels, including opposing solid roller pairs 240 and opposing solid roller starwheel pairs 250. More specifically, in one example, input path portion 202 and print path portion 204 of print media path 200 (before or upstream of print zone 122 relative to direction 204a) include a series of opposing solid roller pairs 240, and output path portion 206 and print path portion 204 of print media path 200 (after or downstream of print zone 122 relative to direction 204a) include a series of opposing solid roller starwheel pairs 250, with the starwheels provided to the printed sided of the print media (to minimize contact with the printed sided of the print media). In addition, in one example, an initial segment or length of duplexing path portion 224 of duplex media path 220 (as communicated with and extended from reversing path portion 222) includes a series of opposing solid roller starwheel pairs 250, with the starwheels provided to the printed sided of the print media (to minimize contact with the printed sided of the print media), and a final segment or length of duplexing path portion 224 of duplex media path 220 (as communicated with and extended to input path portion 202) includes a series of opposing solid roller pairs 240.

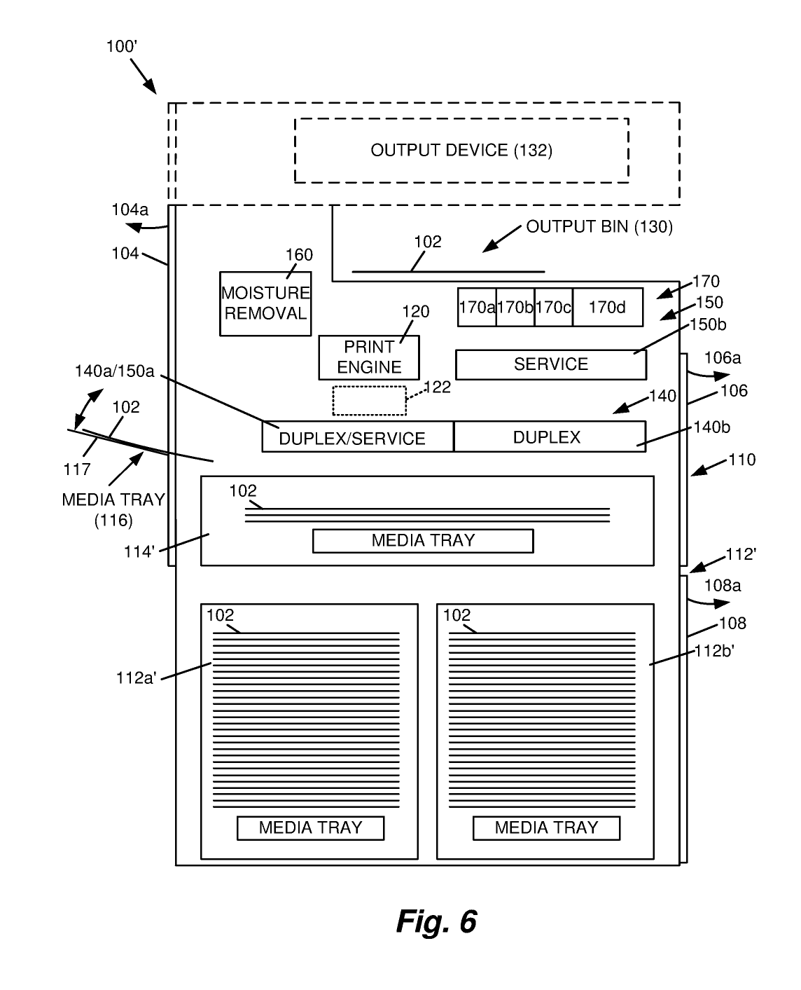

FIG. 6 is a schematic illustration of one example of a layout of a portion of a printer 100′. In one implementation, similar to printer 100, printer 100′ includes input trays 110 to supply print media 102, print engine 120 to print on print media 102, output tray or bin 130 to receive printed print media 102, duplex module 140 to facilitate two-sided printing on print media 102, and service modules 150 to service print engine 120. In addition, printer 100′ includes moisture removal unit 160 to facilitate removal of moisture from printed print media 102 and, in one implementation, includes additional output device 132 to receive printed print media 102.

In one implementation, input trays 110 of printer 100′ include a tandem media tray set 112′, a media tray 114′, and manual or bypass media tray 116. In one example, tandem media tray set 112′ includes a tandem media tray 112a′ and a tandem media tray 112b′. Tandem media tray 112a′ and tandem media tray 112b′ are positioned side-by-side or laterally of each other, and each hold a separate quantity of print media. In one example, tandem media tray 112a′ and tandem media tray 112b′ are each high capacity media trays. For example, in one implementation, tandem media tray 112a′ and tandem media tray 112b′ each have a 2000 sheet capacity for a combined capacity of 4000 sheets.

As described above, print area or print zone 122 is defined in which printing on print media 102 by print engine 120 occurs, and output bin 130 is provided at an end of a print media path through printer 100. In addition, bypass media tray 116 includes door 117 which is selectively opened (and closed) (as indicated by the double arrow) to facilitate manual input of print media 102 to printer 100. Furthermore, duplex module 140, including duplex sub-modules 140a and 140b, can be operated to facilitate printing on both sides of print media 102, and service modules 150a and/or 150b provide for servicing of print engine 120.

In addition, as described above, moisture removal unit 160 facilitates removal or reduction of moisture from printed print media, and printing fluid supply 170 includes quantities of different colored liquid inks, such as yellow 170a, cyan 170b, magenta 170c, and black 170d, to supply printing fluid to print engine 120. Furthermore, access doors 104, 106, and/or 108 (openable in the direction indicated by arrows 104a, 106a, and 108a) provide access to internal of printer 100′, for example, for the clearance of print media jams and/or other service, including access to output device 132 (when present).

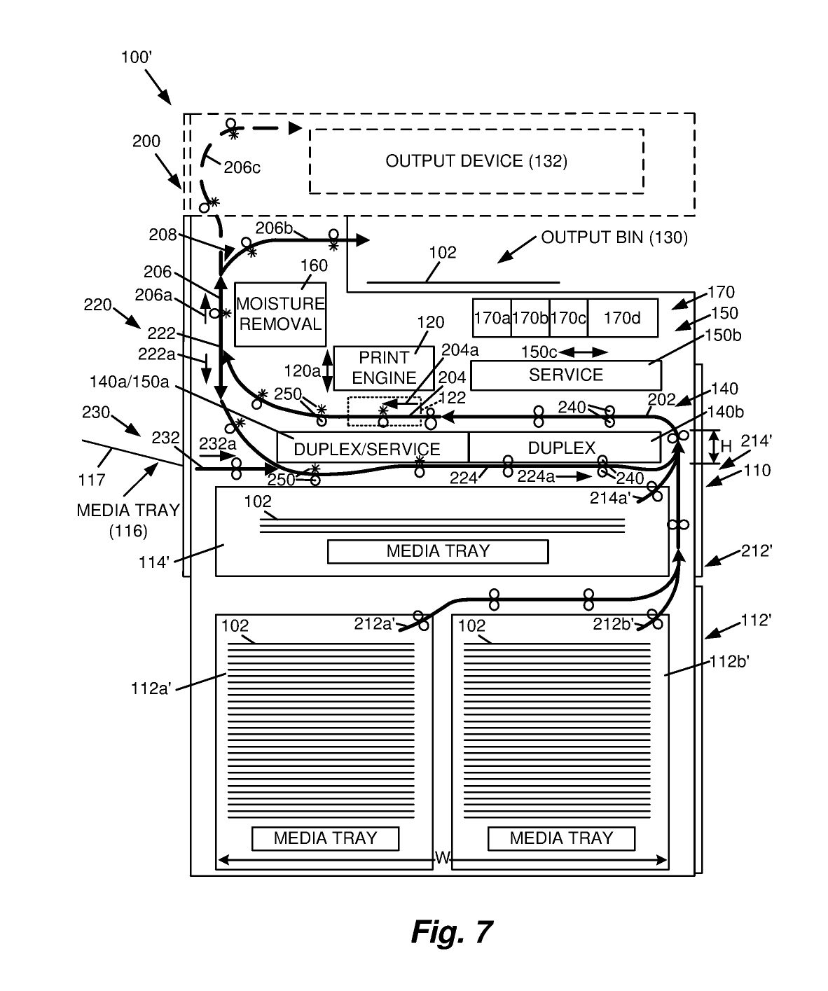

FIG. 7 is a schematic illustration of one example of a media handling layout of printer 100′. In one implementation, similar to printer 100, and with reference to FIG. 6, printer 100′ includes print media path 200 which routes print media 102 through printer 100′ for printing on print media 102 by print engine 120. As described above, print media path 200 includes input path portion 202, print path portion 204, and output path portion 206. As such, input path portion 202 communicates with and receives input of print media 102 from tandem tray media path 212′ communicated tandem media tray set 112′, including tandem media tray 112a′ and/or tandem media tray 112b′, from media path 214′ communicated with media tray 114′, and/or from bypass media path 230 communicated with bypass media tray 116 such that, in one implementation, input path portion 202 provides a common input path for tandem media tray set 112′, media tray 114′, and bypass media tray 116.

In addition, similar to printer 100, printer 100′ includes duplex media path 220 which receives print media 102 and redirects print media 102 to print media path 200 to facilitate printing on a second side of print media 102. As described above, duplex media path 220 includes reversing path portion 222 and duplexing path portion 224. Furthermore, similar to printer 100, printer 100′ includes bypass media path 230 which communicates with and extends between bypass media tray 116 and print media path 200. As described above, bypass media path 230 includes bypass path portion 232 which directs print media 102 to input path portion 202 of print media path 200.

In one implementation, tandem media tray path portions 212a′ and 212b′ communicate with and extend between respective tandem media trays 112a′ and 112b′ and input path portion 202. In one example, tandem media tray path portions 212a′ and 212b′ include a common or shared media path portion as communicated with input path portion 202. As such, a compact arrangement of tandem media tray path portions 212a′ and 212b′ and input path portion 202 is obtained. In addition, in one implementation, media path portion 214a′ communicates with and extends between media tray 114′ and input path portion 202.

In one implementation, as outlined above, tandem media tray path portions 212a′ and 212b′, media path portion 214a′, bypass path portion 232, and duplexing path portion 224 communicate with and extend to input path portion 202 such that input path portion 202 provides a converging path portion of print media path 200. As such, a compact arrangement of print media path 200, duplex media path 220, and bypass media path 230 is obtained.

As schematically illustrated in the examples of FIGS. 5 and 7, components of printer 100, 100′ are arranged to provide a compact and efficient design of printer 100, 100′. For example, duplex module 140 is positioned vertically of (viz., vertically above) tandem media tray set 112, 112′, and duplexing path portion 224 extends a width (W) of tandem media tray set 112, 112′, including a combined width (W) of tandem media tray 112a, 112a′ and tandem media tray 112b, 112b′, between opposite sides of tandem media tray set 112, 112′. As such, an overall length of duplex media path 220 is increased such that one sheet of print media may be positioned or “parked” in duplexing path portion 224 while another sheet of print media is routed or “fed” to print path portion 204. In addition, the increased length of duplex media path 220 provides additional drying time for printed print media as the printed print media is redirected or rerouted to print media path 200.

In addition, bypass media tray 116 is positioned adjacent and laterally of duplex module 140 and overlaps duplex module 140 in a vertical position or direction such that bypass media tray 116 is “nested” within a height (H) of duplex module 140 between a bottom and a top of duplex module 140. As such, bypass path portion 232 overlaps duplexing path portion 224 in a vertical position or direction.

In one implementation, service module 150a is combined with duplex module 140 including, more specifically, duplex sub-module 140a, and is positioned vertically of (viz., vertically above) tandem media tray 112a, 112a′ and is spaced from and positioned vertically of (viz., vertically below) print engine 120 in an area under print zone 122. In addition, service module 150b is positioned vertically of (viz., vertically above) duplex module 140 including, more specifically, duplex sub-module 140b, and is spaced from and positioned adjacent and laterally of print engine 120 (during non-servicing of print engine 120) such that print engine 120 is moved vertically (as indicated by double arrow 120a) and service module 150b is moved horizontally (as indicated by double arrow 150c) to service print engine 120.

In one implementation, moisture removal unit 160 is positioned vertically of (viz., vertically above) service module 150a and duplex module 140, and printing fluid supply 170 is positioned vertically of (viz., vertically above) service module 150b.

In one implementation, output bin 130 (and output device 132) “overlaps” a footprint of (or is “nested” within) printer 100, 100′ such that minimal overhang of outputted print media 102 occurs beyond output bin 130 (or output device 132). As such, with minimal overhang of outputted print media 102 from output bin 130 (or output device 132), an operational width of printer 100, 100′ and, therefore, an occupied footprint of printer 100, 100′, may be reduced.

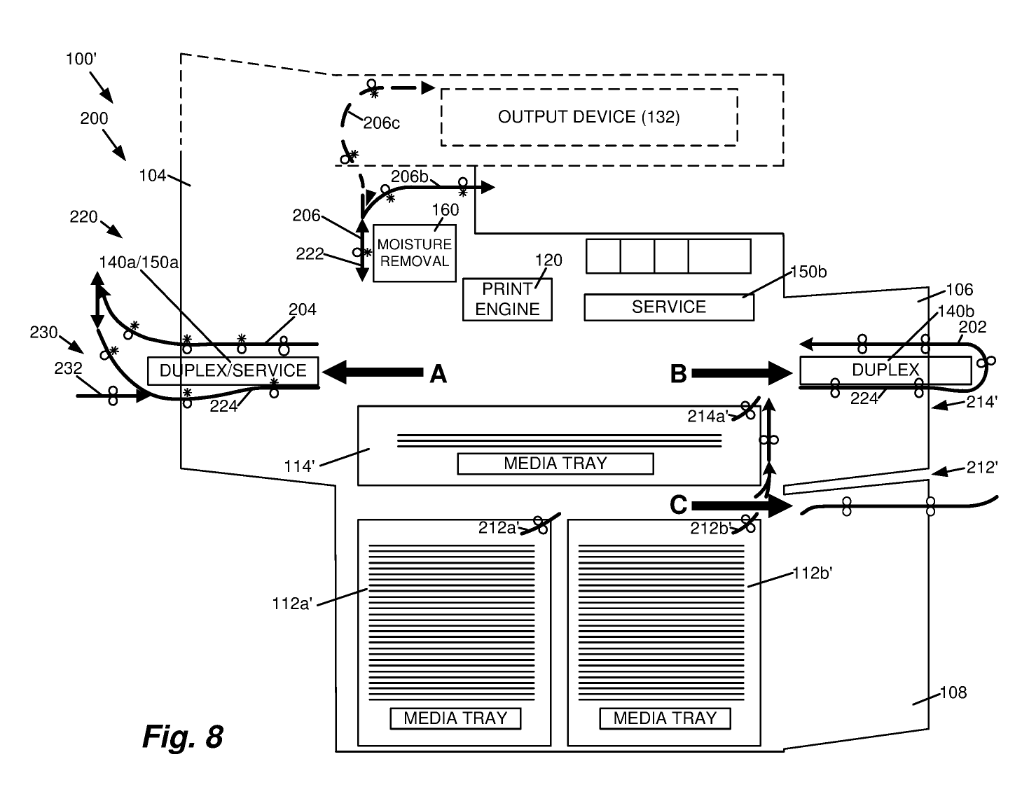

FIG. 8 illustrates one example of an internal access configuration of printer 100′ (with printer 100 including similar access). In one implementation, as described above, access doors 104, 106, and/or 108 provide access to internal of printer 100′, for example, for the clearance of print media jams and/or other service.

In one example, with access door 104 opened, combined duplex sub-module 140a and service module 150a may be removed (fully or at least partially) from printer 100′, as represented by arrow A. As such, print path portion 204 of print media path 200, at least a portion of duplexing path portion 224 of duplex media path 220, and bypass path portion 232 of bypass media path 230 may be accessed. In addition, output path portion 206 of print media path 200 (including output path portion 206b and output path portion 206c), and reversing path portion 222 of duplex media path 220 may be accessed. Thus, print media path 200 (including guides, rollers, wheels thereof), along an output side thereof, from above media tray 114′ up to and including, for example, output device 132, may be accessed. As such, a user may access and clear possible jams effectively and efficiently. Furthermore, print engine 120 and moisture removal unit 160 may be accessed through opened access door 104.

In addition, with access door 106 opened, duplex sub-module 140b may be removed (fully or at least partially) from printer 100′ as represented by arrow B. As such, input path portion 202 of print media path 200, and at least a portion of duplexing path portion 224 of duplex media path 220 may be accessed. In addition, media path 214′ (including media path portion 214a′) may be accessed. Thus, print media path 200 (including guides, rollers, wheels thereof), along an input side thereof, may be accessed. As such, a user may access and clear possible jams effectively and efficiently. Furthermore, service module 150b may be accessed through opened access door 106.

Furthermore, with access door 108 opened, a media cassette providing media routing from tandem media tray 112a′ to input path portion 202 maybe removed (fully or at least partially) from printer 100′ as represented by arrow C. As such, tandem media path 212′ (including tandem media path portions 212a′ and 212b′) may be accessed.

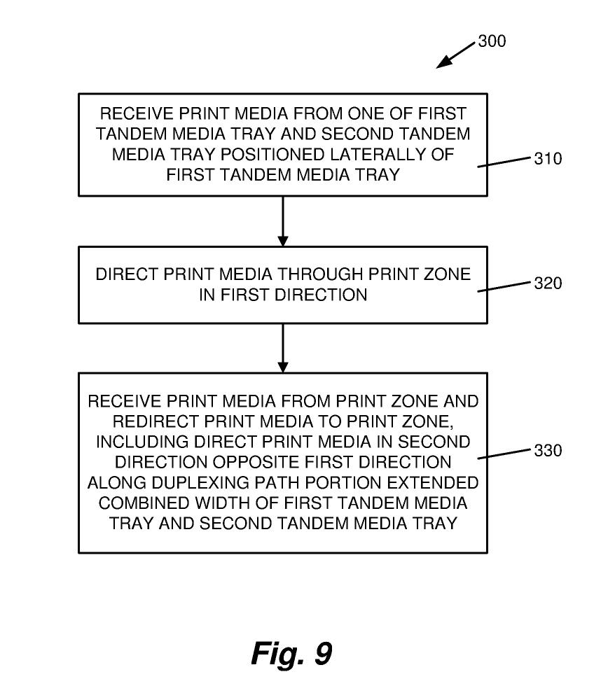

FIG. 9 is a flow diagram illustrating one example of a method 300 of operating a printer, such as printer 100, 100′. With method 300, at 310, print media, such as print media 102, is received from one of a first tandem media tray and a second tandem media tray positioned laterally of the first tandem media tray, such as tandem media tray 112a, 112a′ or tandem media tray 112b, 112b′, as schematically illustrated in the example of FIGS. 5 and 7.

At 320, the print media, such as print media 102, is directed through a print zone of the printer, such as print zone 122 of printer 100, 100′, in a first direction, such as direction 204a, as schematically illustrated in the example of FIGS. 5 and 7. More specifically, the print media is directed along a print media path, such as print media path 200, as schematically illustrated in the example of FIGS. 5 and 7. In one example, the print media is directed along an input path, such as input path portion 202, and directed along a print path, such as print path portion 204, in the direction indicated by arrow 204a. As such, print engine 120 may print on the print media as the print media is routed through print zone 122.

At 330, the print media, such as print media 102, is received from the print zone, such as print zone 122, and redirected to the print zone, such as print zone 122, as schematically illustrated in the example of FIGS. 5 and 7. More specifically, redirecting the print media to the print zone includes directing the print media in a second direction opposite the first direction, such as the direction indicated by arrow 224a. In one example, redirecting the print media to the print zone includes directing the print media along a duplexing path portion extended a combined width of a first tandem media tray and a second tandem media tray, such as duplexing path portion 224 extended a combined width (W) of tandem media tray 112a, 112a′ and tandem media tray 112b, 112b′, as schematically illustrated in the example of FIGS. 5 and 7.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A printer, comprising:
a print engine to print on print media within a print zone;
a print media path including a print path portion to direct the print media through the print zone in a first direction;
a duplex media path including a duplexing path portion to redirect the print media to the print media path in a second direction opposite the first direction; and
a first tandem media tray to hold a first quantity of the print media and a second tandem media tray positioned laterally of the first tandem media tray to hold a second quantity of the print media,
wherein the duplexing path portion extends a combined width of the first tandem media tray and the second tandem media tray.

2. The printer of claim 1, wherein the print media path includes an output path portion to direct the print media toward an output, including in a third direction substantially perpendicular to the first direction, wherein the output path portion provides a reversing path portion of the duplex media path.

3. The printer of claim 1, further comprising:
a bypass media path to receive print media from externally of the printer and direct the print media to the print media path via the duplexing path portion of the duplex media path.

4. The printer of claim 3, wherein the print media path includes a converging path portion to receive print media from the bypass media path, the duplex media path, a tandem tray media path communicated with at least one of the first tandem media tray and the second tandem media tray, and an auxiliary media path communicated with at least one auxiliary media tray.

5. The printer of claim 1, wherein the duplexing path portion is to receive print media from one of the first tandem media tray and the second tandem media tray at an intermediate portion thereof and direct the print media to the print media path.

6. The printer of claim 1, further comprising:
at least one service module to service the print engine, the at least one service module positioned one of laterally and vertically of the print engine, and positioned vertically of at least one of the first tandem media tray and the second tandem media tray.

7. A printer, comprising:
a print engine to print on print media within a print zone;
a tandem media tray set including a first tandem media tray to hold a first quantity of the print media and a second tandem media tray positioned laterally of the first tandem media tray to hold a second quantity of the print media;
a service module to service the print engine, the service module positioned laterally of the print engine and vertically of one of the first tandem media tray and the second tandem media tray; and
another service module to service the print engine, the another service module positioned vertically of the print engine and vertically of the other of the first tandem media tray and the second tandem media tray.

8. The printer of claim 7, further comprising:
a print media path including a print path portion to direct the print media through the print zone in a first direction; and
a duplex media path including a duplexing path portion to redirect the print media to the print media path in a second direction opposite the first direction.

9. The printer of claim 8, wherein the duplexing path portion extends a width of the tandem media tray set.

10. The printer of claim 8, wherein the print media path includes a converging path portion to receive print media from the duplex media path, a tandem tray media path communicated with the tandem media tray set, an auxiliary media path communicated with at least one auxiliary media tray, and a bypass media path communicated with a bypass media tray communicated externally of the printer.

11. The printer of claim 8, further comprising:
a tandem tray media path portion to receive print media from at least one of the first tandem media tray and the second tandem media tray and direct the print media to an intermediate portion of the duplexing path portion for direction to the print media path via the duplex media path.

12. A method of operating a printer, comprising:
receiving print media from one of a first tandem media tray and a second tandem media tray positioned laterally of the first tandem media tray;
directing the print media through a print zone in a first direction; and
receiving the print media from the print zone and redirecting the print media to the print zone, including directing the print media in a second direction opposite the first direction along a duplexing path portion extended a combined width of the first tandem media tray and the second tandem media tray.

13. The method of claim 12, further comprising:
receiving print media from a bypass media tray communicated externally of the printer and directing the print media from the bypass media tray in the second direction along a bypass path portion to the duplexing path portion and to the print zone via the duplexing path portion.

14. The method of claim 12, wherein receiving print media from one of the first tandem media tray and the second tandem media tray includes directing the print media to an intermediate portion of the duplexing path portion and to the print zone via the duplexing path portion.

15. The method of claim 12, wherein the print media is to be printed on by a print engine, and further comprising:
servicing the print engine with at least one of a service module to be positioned laterally of the print engine and vertically of one of the first tandem media tray and the second tandem media tray during non-servicing of the print engine and a service module positioned vertically of the print engine and vertically of the other of the first tandem media tray and the second tandem media tray.
